(19) United States
(12) Patent Application Publication
(10) Pub. No.: US 2015/0295337 A1
(43) Pub. Date: Oct. 15, 2015

(54) METHOD AND STRUCTURE FOR CONDUCTIVE ELASTOMERIC PIN ARRAYS USING SOLDER INTERCONNECTS AND A NON-CONDUCTIVE MEDIUM AND INDIVIDUAL SOLDERABLE COMPRESSION STOPS

(71) Applicant: R&D Sockets,Inc, Allentown, PA (US)

(72) Inventors: Charles William Martin, Wind Gap, PA (US); James V. Russell, New Hope, PA (US); Thomas P. Warwick, Melbourne, PA (US); Demick McMullin, Catasauqua, PA (US); William Quick, Belleville, NJ (US)

(73) Assignee: R&D Sockets,Inc, Allentown, PA (US)

(21) Appl. No.: 14/533,406

(22) Filed: Nov. 5, 2014

Related U.S. Application Data
(63) Continuation-in-part of application No. 61/978,280, filed on Apr. 11, 2014.

(51) Int. Cl. H01R 13/24; H01R 43/00

(52) U.S. Cl. CPC H01R 13/2414; H01R 43/007

(57) ABSTRACT

A method and structure is provided for constructing elastomeric pin arrays using solder interconnects and a non-conductive medium. Pin to pin interconnects are constructed using a solder connection through a non-conductive medium. This structure eliminates the need for PCB structures as the medium, reducing manufacturing cost. In another embodiment a non conductive medium has holes therein and serves as a compression stop. One or more first elastomeric column is formed on an upper side of a conductive disc. The conductive disc is fixedly adhered to a pad located on an underside of the non conductive medium aligned so that the one or more first elastomeric column extends through said holes of the non conductive medium. One or more second elastomeric column is formed on an underside or bottom of the conductive medium or disc. A compression stop serves as a compression stop for said underside or bottom elastomeric column

### RELATED APPLICATIONS

The present application is a non provisional application of provisional application Ser. No. 61/978,280 filed by Charles Martin, et al. on Apr. 30, 2014.

### BACKGROUND

1. Field

The present invention relates to a method and structure for improving conductive elastomeric interposer manufacture. In particular, the present invention provides a structure of an elastomeric interposer without a PCB substrate and a method for constructing the same.

2. The Related Art

Typically PCB structures are required as mediums when structuring interconnects. It would be desirable to eliminate the need for PCB structures as mediums thereby reducing manufacturing costs. The present invention accomplishes this by using pin to pin or pin structure interconnects using a solder connection through a non-conductive medium. In this way an elastomeric structure is constructed without a PCB substrate. The conductive elastomer interconnects by incorporating an electrically conductive material substrate such as but not limited to a metallic substrate such as but not limited to conductive metal disks that are soldered together through one or more holes or openings in the non-conductive medium. This structure forms the electrical interconnect and eliminates the need for a PCB based through via/pad structure.

### SUMMARY

It would be desirable to provide a method and structure for improving conductive elastomer interposer manufacture. This is accomplished by providing a method and structure for constructing conductive elastomer arrays using a non-conductive medium and solder interconnects.

### BRIEF DESCRIPTION OF THE DRAWINGS

FIG. 1 is a sectional view of the present invention;

FIG. 2 is a sectional view of the present invention showing the elastomeric pin connections on both sides of the interconnect and circuit or components connected on either side of the interconnect with optional compression stops;

FIG. 3 is another embodiment of the present invention in which a metal disk is formed with a post or column formed on one side to a specific height of preferably approximately 5 mils to 15 mils to restrict compression of adjacent compliant electrical interconnects such as spring pins or conductive elastomeric pins and the individual compression stop pin may be picked and placed onto metal pads or dielectric surfaces of printed circuit boards or other electrical interconnect substrates through hand placement or by automation; and

FIG. 4 is another embodiment of the present invention with one or more elastomeric columns extending through holes or openings in said non conductive medium and being fixedly secured within said holes and with compression stops being provided on both sides of each elastomeric column for both the upper and bottom surfaces of the non conductive medium.

### DETAILED DESCRIPTION OF THE PREFERRED EMBODIMENT(S)

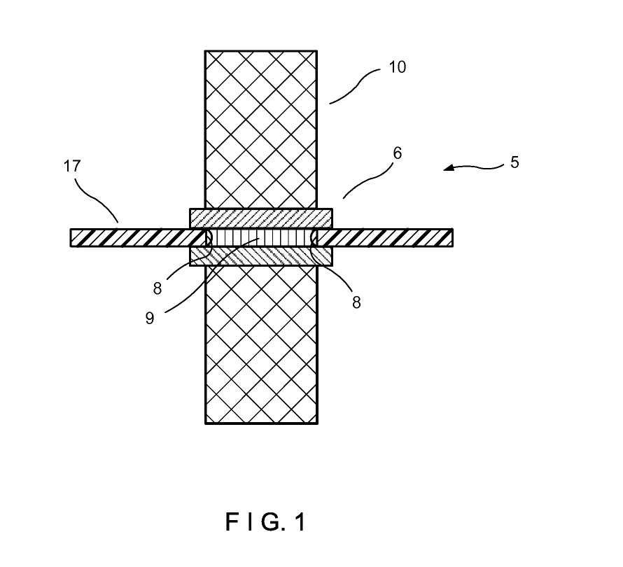

This application references applicant's pending application Ser. No. 13/815,737 filed on Mar. 15, 2013 and incorporates the subject matter in its entirety therein by reference thereto. Referring now to FIG. 1 of the drawings, FIG. 1 shows a sectional view of the present invention in which an electrical interconnect 5 is formed with a conductive elastomer 10. The conductive elastomer 10 is fixedly or securely placed on a surface of an electrically conductive material such as but not limited to a metallic substrate such as but not limited to a metallic disk 6. The elastomer 10 can be fixedly placed on the disks 6 by curing where the elastomer in an uncured state formed on the disk then solidifies through the curing process. Alternatively the disks 6 can have additional small holes or crevices or nodules or protrusions for the cured elastomer to take root in or around and hold in place when it solidifies. The disks 6 are located on a non-conductive medium 7 which has one or more holes or openings 8. The non-conductive medium can be any commercially available material such as but not limited to Kapton material or FR 4-fire retardant material. A solder interconnect 9 is provided in the one or more holes or openings 8 of the non-conductive medium to solder the metallic disks 6 in place thus forming the electrical interconnect 5. This structure eliminates the need for a printed circuit board (PCB) based through a via/pad structure and is therefore also more cost effective from a manufacturing perspective.

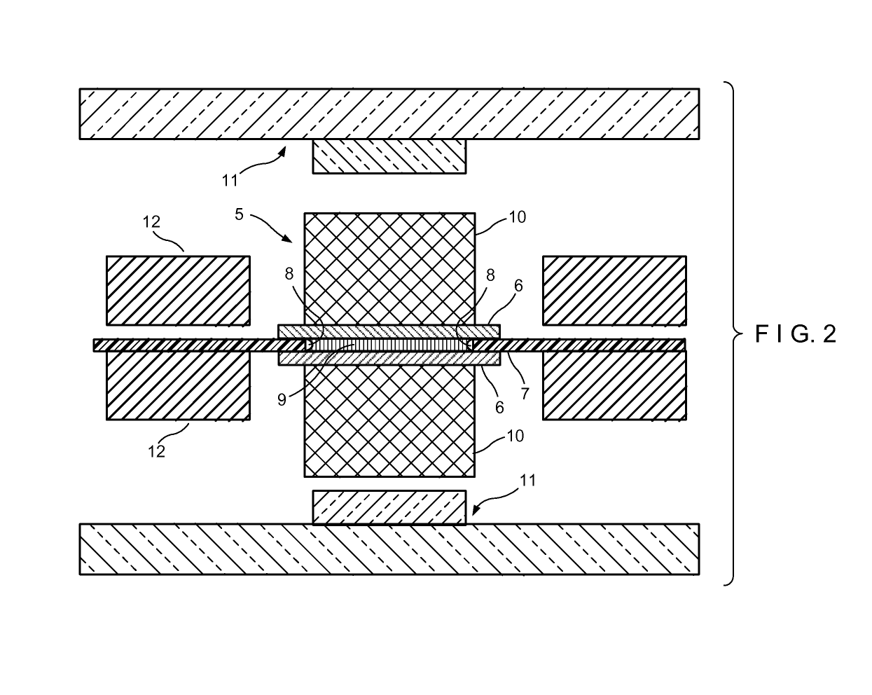

FIG. 2 shows the elastomeric pins 10 on each side of the interconnect 5 of the present invention. Each pin 10 is fixedly or securely placed on a respective surface of a metallic substrate 6 such as a metallic disk 6. The disks 6 are located on non-conductive medium 7 having one or more holes or openings 8. Solder interconnect 9 is placed within the one or more holes or openings 8 to form the electrical interconnect 5. Circuits or components on each side of the electrical interconnect 5 can be connected to the electrical interconnect 5 with optional compression stops 12.

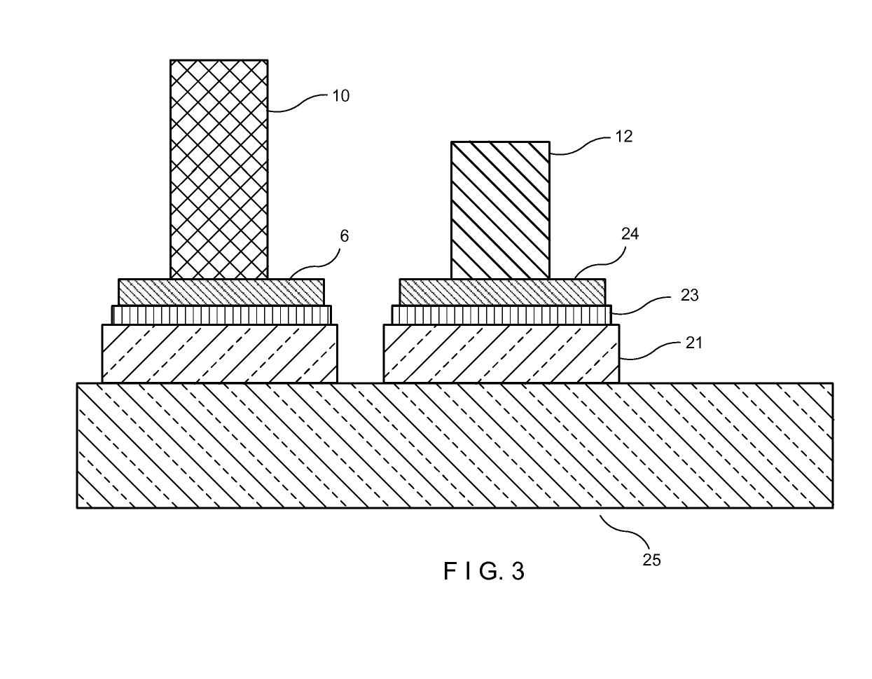

FIG. 3 is another embodiment of the present invention which replaces the need for a sheet compression stop in a compliant electrical interconnect structure. A metal disk 6 is formed with a post or column 10 formed on one side to a specific height to restrict or limit the compression of adjacent compliant electrical interconnects such as spring pins or conductive elastomeric pins 10. This individual compression stop pin 12 may be picked and placed onto metal pads or dielectric surfaces of printed circuit boards 25 or other electrical interconnect substrates through hand placement or by automation. The pin 12 can be soldered 23 to metallic pads 24 on such substrates, glued or adhered with adhesive to pads or dielectric surfaces. This embodiment of the present invention saves time and money though material savings as well as provides for ease of placement of the pin where required and the ability to place only a limited number of pins where required as opposed to sheet compression stops that cover an entire area of the array of pins.

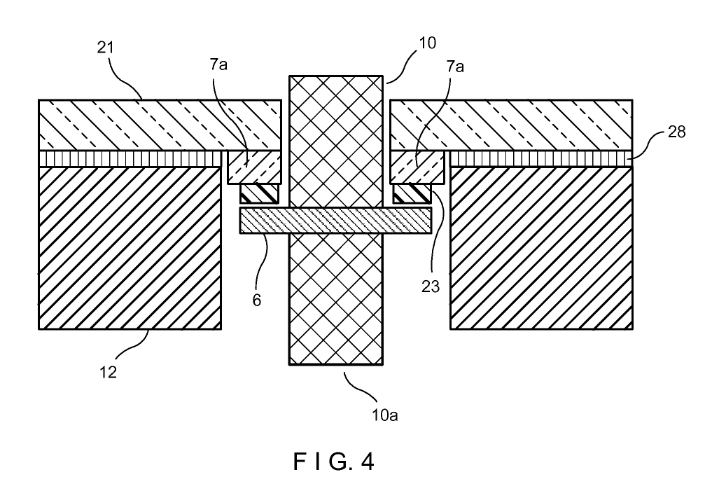

FIG. 4 is another embodiment of the present invention. In FIG. 4 one or more elastomeric columns 10 extend through holes or openings in the non conductive medium 7a, which also serves as a compression stop for the top elastomeric column 10. The elastomeric column 10 is formed onto conductive disc 6, with the conductive disc 6 in turn being fixedly adhered to pad 21 with preferably either solder or adhesive material. In addition a second elastomeric column 10a is formed on the underside of the conductive medium or disc 6. Compession stop 12 serves as a compression stop for the bottom elastomeric column 10a . The compression stops 7a, 12 serve to limit the compression of the height of the elastomeric columns 10, 10a. The compression stops 7a, 12 preferably have a thickness of approximately 50 percent of the height of said one or more elastomers so as to limit compression of said elastomers 10, 10a to 40 to 50 percent of their respective heights.

While certain embodiments have been shown and described, it is distinctly understood that the invention is not limited thereto but may be otherwise embodied within the scope of the appended claims.

What is claimed:

1. An electrical interconnect, comprising:
a conductive elastomer fixedly placed on a surface of an electrically conductive substrate;
said substrate being located on a non-conductive medium having one or more holes or openings therein; and
said one or more holes or openings having a solder interconnect within to solder said electrically conductive substrate to a second said conductive substrate having a second conductive elastomer fixedly placed on the opposite surface of said non-conductive medium to form said electrical interconnect thereby eliminating the need for a printed circuit board (PCB) based through a via/pad structure and being more cost effective from a manufacturing perspective.

2. The electrical interconnect according to claim 1 wherein said electrically conductive substrate is an electrically conductive metallic substrate.

3. The electrical interconnect according to claim 2 wherein said metallic substrate is a metallic disk.

4. The electrical interconnect according to claim 1 wherein said electrical interconnect can be connected to an electrical circuit or a component.

5. The electrical interconnect according to claim 3 wherein said elastomer is fixedly placed onto said disk by curing said elastomer and allowing said elastomer to solidify onto said disk.

6. The electrical interconnect according to claim 5 wherein said disk has crevices, holes nodules or protrusions into or around which said elastomer partially flows during curing and then solidifies within or around to firmly place said elastomer onto said disk.

7. The electrical interconnect according to claim 1 wherein said nonconductive medium is made of Kapton material.

8. An electrical interconnect comprising a metal disk is formed with a post or column formed on one side to a specific height to restrict compression of an adjacent compliant electrical interconnect that acts as an individual compression stop, said individual compression stop pin being placed onto dielectric surfaces of printed circuit boards or other electrical interconnect substrates so as to facilitate ease of placement of the pin where required and to place only a limited number of pins where required thereby eliminating the need for sheet compression stops covering an entire area of the array of pins.

9. An electrical interconnect comprising a non conductive medium having holes therein and servings as a compression stop and wherein one or more first elastomeric column is formed on an upper side of a conductive disc, said conductive disc in turn being fixedly adhered to a pad located on an underside of the non conductive medium aligned so that the one or more first elastomeric column extends through said holes of said non conductive medium, and wherein one or more second elastomeric column is formed on an underside or bottom of the conductive medium or disc and a compession stop serves as a compression stop for said underside or bottom elastomeric column

10. The electrical interconnect according to claim 9 wherein is adhered to said pad by ether solder or adhesive material.

11. The electrical interconnect according to claim 9 wherein said compression stops have a width of approximately 50 percent of the height of said one or more first and second elastomeric column so as to limit compression of said elastomers to 40 to 50 percent.

12. A method for constructing an electrical interconnect, the steps comprising: fixedly placing a conductive elastomer on a surface of an electrically conductive substrate; locating said electrically conductive substrate on a non-conductive medium having one or more holes or an openings therein; and
filling said one or more holes or openings with a solder interconnect solder said electrically conductive substrate to said non-conductive medium to form said electrical interconnect thereby eliminating the need for a printed circuit board (PCB) based through a via/pad structure and being more cost effective from a manufacturing perspective.

13. The method according to claim 12 further comprising the step of connecting said electrical interconnect to an electrical circuit or a component.

14. A method for constructing an electrical interconnect the steps comprising forming a metal disc to a post or column formed on one side to a specific height to restrict compression of an adjacent compliant electrical interconnect acting as an individual compression stop, and placing said individual compression stop pin onto dielectric surfaces of a printed circuit boards or other electrical interconnect substrates so as to facilitate ease of placement of the pin where required and to place only a limited number of pins where required thereby eliminating the need for sheet compression stops covering an entire area of the array of pins.

15. A method for constructing an electrical interconnect the steps comprising providing holes in a non conductive medium that serves as a compression stop and forming one or more first elastomeric column on an upper side of a conductive disc, said conductive disc, in turn being fixedly adhered to a pad located on an underside of the non conductive medium and aligned so that said one or more first elastomeric column extends through said holes of said non conductive medium, and forming one or more second elastomeric column on an underside or bottom of the conductive medium or disc and placing a compression stop that serves as a compression stop on the underside or bottom elastomeric column.

16. The method according to claim 15 wherein said compression stops have a width of approximately 50 percent of the height of said one or more elastomers so as to limit compression of said elastomers to 40 to 50 percent.

17. The method according to claim 15 further comprising the step of compressing said electrical interconnect between two electrical circuits or components.

18. The method according to claim 15 wherein said electrically conductive substrate is an electrically conductive metallic substrate.

19. The method according to claim 15 wherein said metallic substrate is a metallic disk.

20. The method according to claim 15 wherein said electrical interconnect can be connected to an electrical circuit or a component.

21. The method according to claim 19 further comprising fixedly placing said elastomer fixedly placed onto said electrically conductive disk by curing said elastomer and allowing said elastomer to solidify onto said disk.

22. The method according to claim 19 wherein said disk has crevices, holes nodules or protrusions into or around which said elastomer partially flows during curing and then solidifies within or around to firmly place said elastomer onto said disk.
